(19) United States
(12) Patent Application Publication
(10) Pub. No.: US 2018/0306585 A1
(43) Pub. Date: Oct. 25, 2018

(54) RECORDING MEDIUM, NOTIFICATION METHOD, AND NOTIFICATION APPARATUS

(71) Applicant: FUJITSU LIMITED, Kawasaki-shi (JP)

(72) Inventor: Shinya Yokoi, Kawasaki (JP)

(73) Assignee: FUJITSU LIMITED, Kawasaki-shi (JP)

(21) Appl. No.: 15/953,690

(22) Filed: Apr. 16, 2018

(30) Foreign Application Priority Data
Apr. 21, 2017 (JP) 2017-084894

(51) Int. Cl. G01C 21/20; G01C 23/00; G01S 19/47

(52) U.S. Cl. CPC G01C 21/203; G01S 19/47; G01C 23/00

(57) ABSTRACT

A non-transitory, computer-readable recording medium stores therein a notification program that causes a computer to execute a process including acquiring position information regarding changing positions of a mobile body that moves by wind power; acquiring state information regarding a state of the mobile body at each of the positions; determining whether the state is within a predefined range; and outputting a result of the determination.

### CROSS REFERENCE TO RELATED APPLICATIONS

This application is based upon and claims the benefit of priority of the prior Japanese Patent Application No. 2017-084894, filed on Apr. 21, 2017, the entire contents of which are incorporated herein by reference.

### FIELD

The embodiments discussed herein are related to a recording medium, a notification method, and a notification apparatus.

### BACKGROUND

Generally, it is said that for a mobile body that moves by wind power such as in the case of windsurfing, sailing performance is determined by boat speed and sailing angle (angle formed by a traveling direction of the boat and the wind). It is also said that a good sailing form for efficiently catching the wind is a state in which a mast is standing while a sail is stable. If the mast swings back and forth or left and right or the drawing-in of the sail becomes weak, a change in a flow rate of the wind flowing over the sail causes the wind to escape and leads to a reduction in power, resulting in decreased speed and increased fatigue of a rider. As training to achieve a form to overcome the above situations and to improve steering techniques, operations including video recording sailing performed on the sea with a camera on shore and playing and checking the video, are repeatedly performed.

According to a related prior art, acceleration data from an acceleration sensor, a GPS signal from a GPS receiver, etc. are stored in a storage apparatus in correlation with an acquisition time, and when the acceleration data exceeds a reference value, a bridge number is extracted from moving image data to correlate a disposition position of a joint identified by the bridge number with the measurement position of the acceleration data and to display on a display of a notebook PC, an inspection screen for inspecting a road (see, e.g., Japanese Laid-Open Patent Publication No. 2015-197804).

### SUMMARY

According to an aspect of an embodiment, a non-transitory, computer-readable recording medium stores therein a notification program that causes a computer to execute a process including acquiring position information regarding changing positions of a mobile body that moves by wind power; acquiring state information regarding a state of the mobile body at each of the positions; determining whether the state is within a predefined range; and outputting a result of the determination.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a system configuration of a sailing training support system including a notification apparatus according to an embodiment;

FIG. 2 is an explanatory diagram of an example of a hardware configuration of a sensor;

FIG. 3 is a flowchart of an example of a recording process procedure of the sensor;

FIG. 4 is an explanatory diagram of an example of a format of a GPS value;

FIG. 5 is an explanatory diagram of an example of a format of a nine-axis sensor;

FIG. 6 is a flowchart of an example of a data acquisition process procedure of the nine-axis sensor;

FIG. 7 is an explanatory diagram of an example of a format of data acquired by the sensor;

FIG. 8 is a flowchart of an example of a process procedure of data registration to a database;

FIG. 9 is a block diagram of an example of a hardware configuration of the notification apparatus according to the embodiment;

FIG. 10 is a block diagram of an example of a functional configuration of the notification apparatus according to the embodiment;

FIG. 11 is a flowchart of an example of a data display process procedure;

FIG. 12 is an explanatory diagram of details of classification of running data;

FIG. 13 is a flowchart of an example of an angle data calculation process procedure;

FIG. 14 is an explanatory view of details of a pitch angle calculation;

FIG. 15 is an explanatory view of details of a roll angle calculation;

FIG. 16 is an explanatory diagram of details of a yaw angle calculation;

FIG. 17 is an explanatory view of contents of data display;

FIG. 18 is an explanatory view of contents of data display;

FIG. 19 is an explanatory view of contents of data display;

FIG. 20 is an explanatory view of contents of data display;

FIG. 21 is an explanatory view of contents of data display;

FIG. 22 is an explanatory diagram of details of acceptance criteria;

FIG. 23 is an explanatory diagram of an example of display on a display unit; and

FIG. 24 is an explanatory diagram of another example of display on the display unit.

### DESCRIPTION OF THE INVENTION

First problems associated with the related arts will be described. Windsurfing practice is often performed offshore and the conventional method has a problem in that cameras, etc. can provide only limited images as data. With consideration of the cost of practice, a person practicing may have to check her form herself. Moreover, windsurfing is a sport that deals with the “wind”, which is invisible in the first place, and an optimal sailing form itself has not yet been defined.

Embodiments of a recording medium, a notification method, and a notification apparatus according to the present invention will be described in detail with reference to the accompanying drawings.

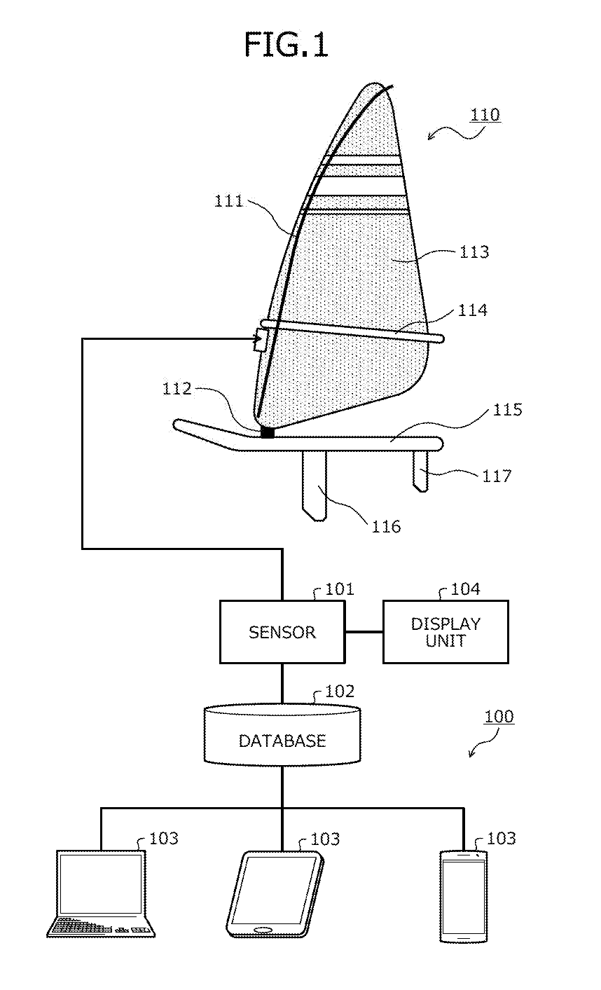

FIG. 1 is an explanatory diagram of an example of a system configuration of a sailing training support system including a display apparatus according to an embodiment. In FIG. 1, a sailing training support system 100 includes a sensor 101, a database 102, and a display apparatus 103.

In FIG. 1, a sailboard 110 is depicted as an example of a mobile body that moves by wind power, i.e., an object of sailing training. The sailboard 110 moves on water while a rider manipulates a dedicated tool in which a rig unit is attached to a board unit 115 (hereinafter, this dedicated tool will sometimes be referred to as a “mobile body 110” or a “sailboard 110”).

The rig unit includes a mast 111, a joint 112, a sail 113, and a boom 114, and the rig unit is attached to the board unit 115 by the joint 112. The board unit 115 includes a daggerboard 116 and a fin 117.

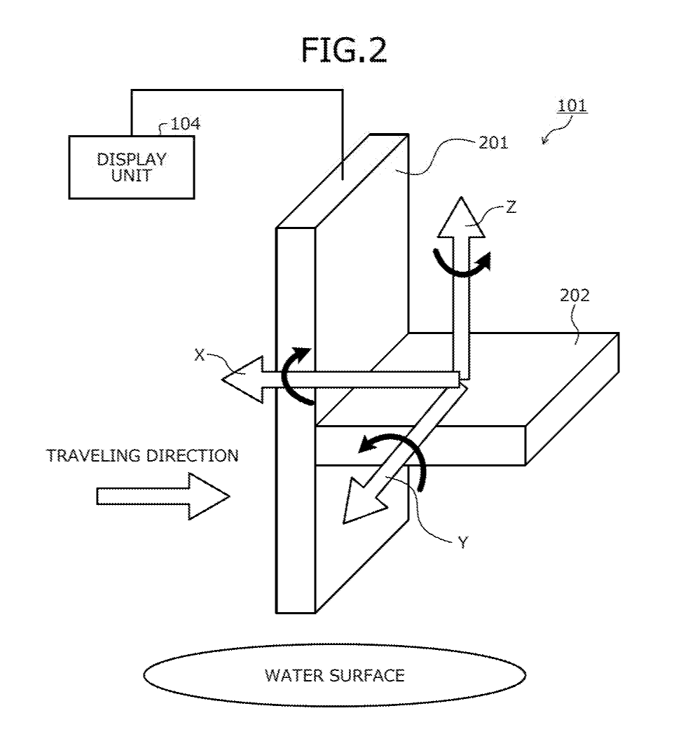

The sensor 101 is attached to the mast 111 slightly below the boom 114. The sensor 101 includes a display unit 104 that is an example of the notification apparatus. Details including attachment of the sensor 101 to the mast 111 will be described later with reference to FIG. 2, etc.

In the sailing training support system 100, the sensor 101 and a database 102 are not directly connected and, for example, data acquired by the sensor 101 is stored to the database 102, through a recording medium such as an SD card not depicted. Alternatively, the sensor 101 and the database 102 may be connected by wireless communication. The sensor 101 and the database 102 may be configured to be connected through a wired or wireless network not depicted.

In the sailing training support system 100, the database 102 and the display apparatus 103 are connected through a wired or wireless network not depicted. The network may be, for example, the Internet, a mobile communications network, a local area network (LAN), or a wide area network (WAN). Therefore, the database 102 may be implemented by a cloud server not depicted. The display apparatus 103 may include the database 102.

The sensor 101 acquires positioning information regarding the position of the sailboard 110 and information regarding the state of the sail 113. The database 102 stores information acquired by the sensor 101. The display apparatus 103 displays various types of information for supporting the sailing training based on the information stored in the database 102.

The display apparatus 103 is a computer used by a user utilizing the sailing training support system 100. The display apparatus 103 is a notebook PC, a desktop PC, a tablet PC, or a smartphone, for example.

FIG. 2 is an explanatory diagram of an example of a hardware configuration of the sensor. In FIG. 2, the sensor 101 is configured to include a base 201 and a nine-axis sensor 202 (e.g., a nine-axis inertia measuring unit). The sensor 101 is connected to the display unit 104.

The nine-axis sensor 202 is provided on the base 201 attached to the mast 111 to be perpendicular to a water surface and parallel to a traveling direction. The base 201 is disposed with a GPS receiving circuit. The sensor 101 simultaneously records GPS (data indicating a running state: speed, traveling direction) and the nine-axis sensor 202 (data indicating a way of riding: three-dimensional sail handling). The sail handling (forward/backward and leftward/rightward tilting of the mast 111, rotation of the mast 111) is recorded by detecting the respective rotation angles of the nine-axis sensor 202 in the X-, Y-, and Z-directions.

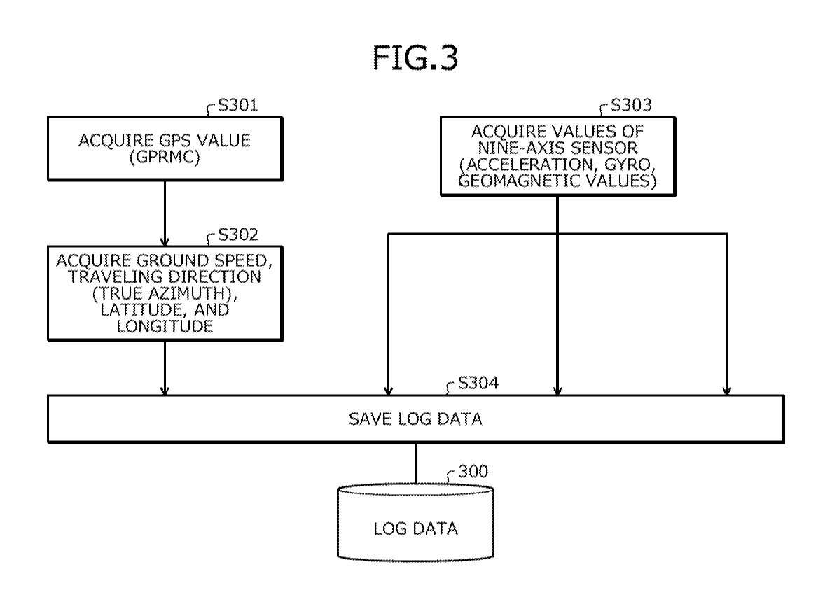

FIG. 3 is a flowchart of an example of a recording process procedure of the sensor. In the flowchart depicted in FIG. 3, the sensor 101 acquires a GPS value (GPRMC) indicating a current position (step S301). From the GPS value acquired at step S301, the sensor 101 acquires the ground speed, the traveling direction (true azimuth), the latitude, and the longitude as log data (step S302).

Simultaneously with the acquisition of the GPS value at step S301, the sensor 101 acquires a value of the nine-axis sensor 202 (step S303). For example, the sensor 101 acquires measurement values from an acceleration sensor, a gyro sensor, and a geomagnetic sensor as log data.

The sensor 101 stores the log data acquired at step S302 and the log data acquired at step S303 to a predetermined storage area (a database 300 of log data) included in the sensor 101 (step S304). The sensor 101 continuously repeats this series of processes during measurement.

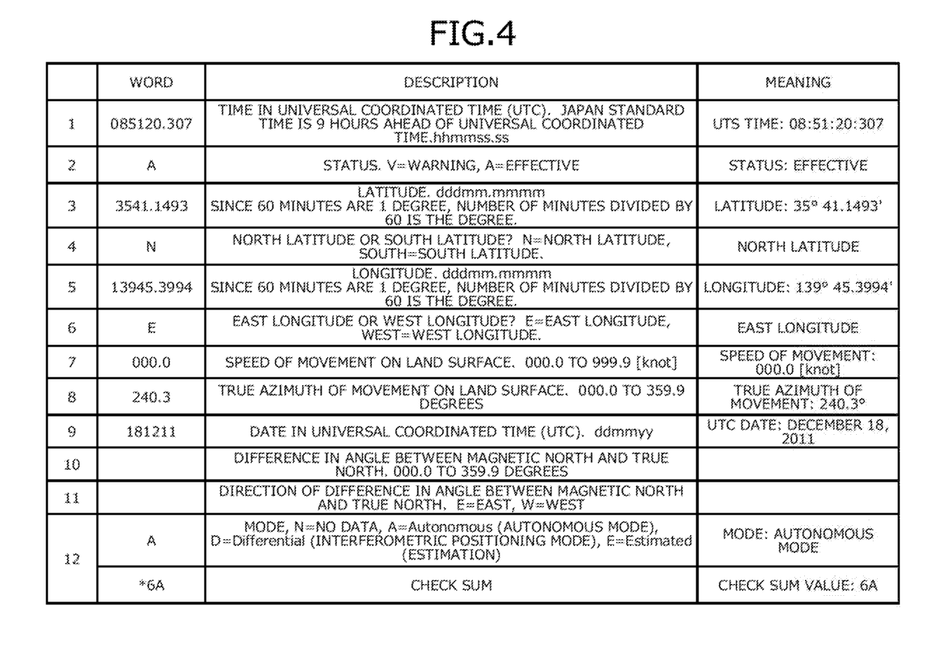

FIG. 4 is an explanatory diagram of an example of a format of the GPS value. The format depicted in FIG. 4 includes the ground speed in item 7, the true azimuth in item 8, the latitude in items 3, 4, and the longitude in items 5, 6.

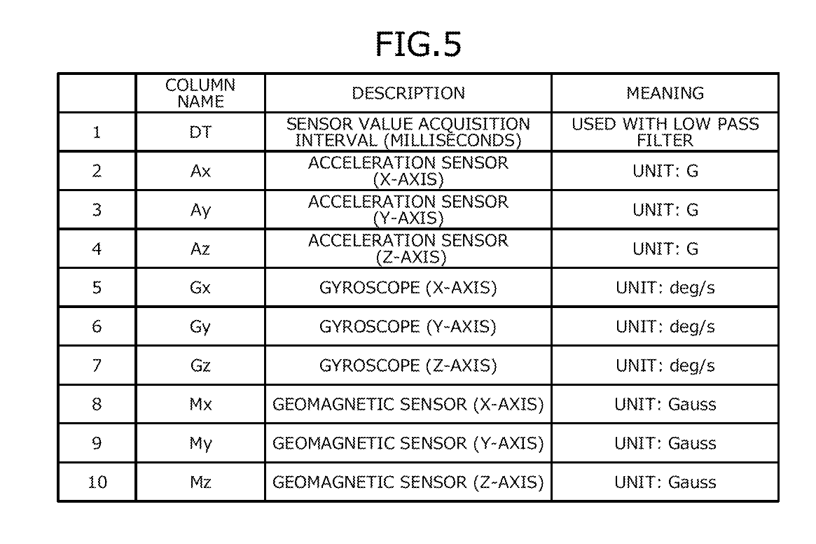

FIG. 5 is an explanatory diagram of an example of a format of the nine-axis sensor. In FIG. 5, Ax, Ay, and Az indicate the acceleration sensor (X-axis), the acceleration sensor (Y-axis), and the acceleration sensor (Z-axis), respectively. Gx, Gy, and Gz indicate the gyroscope (X-axis), the gyroscope (Y-axis), and the gyroscope (Z-axis), respectively. Mx, My, and Mz indicate the geomagnetic sensor (X-axis), the geomagnetic sensor (Y-axis), and the geomagnetic sensor (Z-axis), respectively.

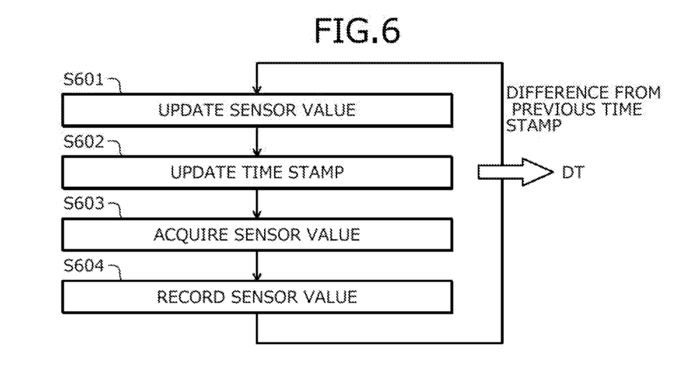

FIG. 6 is a flowchart of an example of a data acquisition process procedure of the nine-axis sensor. In the flowchart depicted in FIG. 6, the nine-axis sensor 202 first updates a sensor value (step S601) and then updates a time stamp (step S602). The nine-axis sensor 202 acquires each sensor value (step S603) and records the acquired sensor values (step S604). Subsequently, the nine-axis sensor 202 returns to step S601 and repeats steps S601 to S604.

In this way, by updating the time stamp at step S602, a difference from the previous time stamp can be obtained as DT (sensor value acquisition interval).

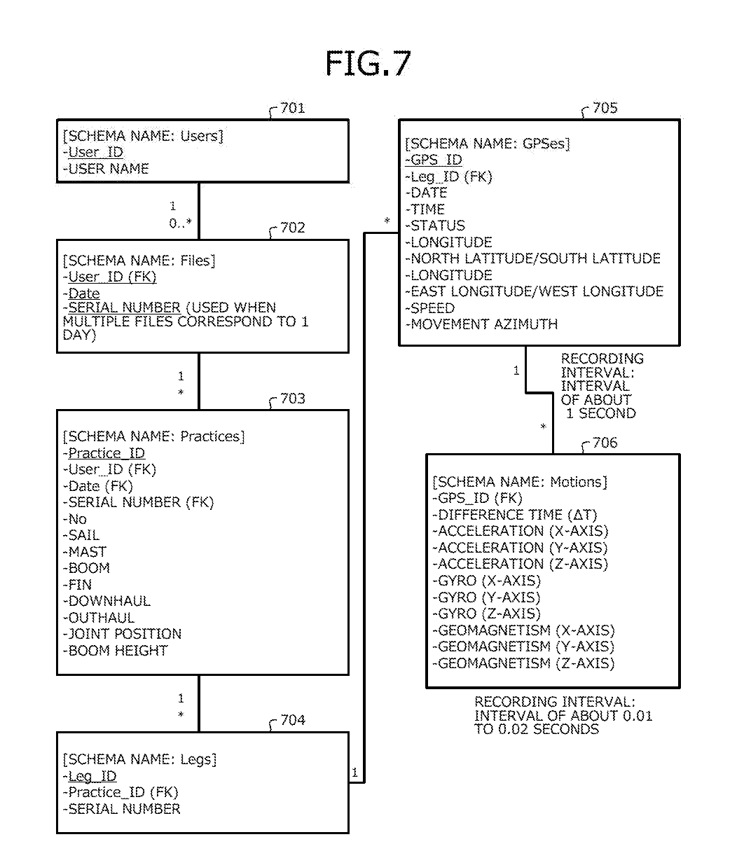

FIG. 7 is an explanatory diagram of an example of a format of data acquired by the sensor. In FIG. 7, User ID of a user is recorded in a schema 701 with a schema name: Users. Thus, the user name is recorded. In a schema 702 with schema name: Files, the User ID is recorded as a foreign key (FK), and Date (date) and a serial number (used when multiple files correspond to one day) are recorded. In other words, a file is managed by a date or a date and the serial number thereof.

In a schema 703 with a schema name: Practices, Practice ID is recorded, and the User ID, the Date, and the serial number are recorded as foreign keys (FK). Additionally, types, etc. of tools of the sailboard 110 are recorded, such as a No (a number assigned to a tool), the sail 113, the mast 111, the boom 114, the fin 117, a downhaul, an outhaul, a joint position, and a boom height.

In a schema 704 with a schema name: Legs, Leg ID is recorded, and the Practice ID is stored as a foreign key (FK). The serial number of the leg is also recorded.

In a schema 705 with a schema name: GPSes, a GPS ID is recorded, and the Leg ID is recorded as a foreign key (FK). The GPS values depicted in FIG. 4 are then recorded, such as date, time, status, longitude, north latitude/south latitude, longitude, east longitude/west longitude, speed, and movement azimuth. The schema 705 is recorded at intervals of about 1 second.

In a schema 706 with a schema name: Motions, the GPS ID is stored as a foreign key (FK). The values of the nine-axis sensor 202 depicted in FIG. 5 are stored such as difference time (ΔT), acceleration (X-axis, Y-axis, Z-axis), gyro (X-axis, Y-axis, Z-axis), and geomagnetism (X-axis, Y-axis, Z-axis). The schema 706 is recorded at intervals of about 0.01 to 0.02 seconds.

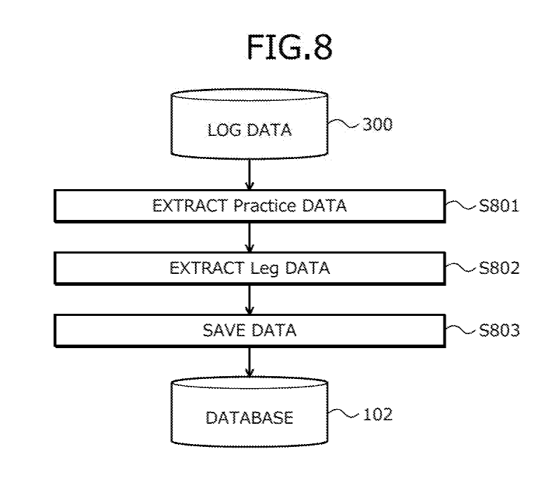

FIG. 8 is a flowchart of an example of a process procedure of data registration to the database. In the flowchart depicted in FIG. 8, first, one-day (one-time) data (data from pressing of a recording start button to pressing of a recording end button) is uploaded for each file, from the log data 300 depicted in FIG. 3.

Practice data is then extracted from the file (step S801). For example, the one-day (one-time) data is divided into pieces of data from one departure to return, and each piece of data excluding a “land waiting time” is defined as “1 Practice”. In the GPS data, when the “movement speed” is 0.5 km/h or less and the speed continues for 10 seconds or more, this is defined as the “land waiting time”.

Leg data is then extracted from the Practice data (step S802). For example, the data is divided into sections from a turn to the next turn, and if a “moving azimuth” in the GPS data is changed by a certain amount or more, five seconds after the change are recognized as “1 Leg”.

Then, extracted pieces of the Practice data and the Leg data are respectively stored (saved) in the database 102 (step S803), and the series of operations ends.

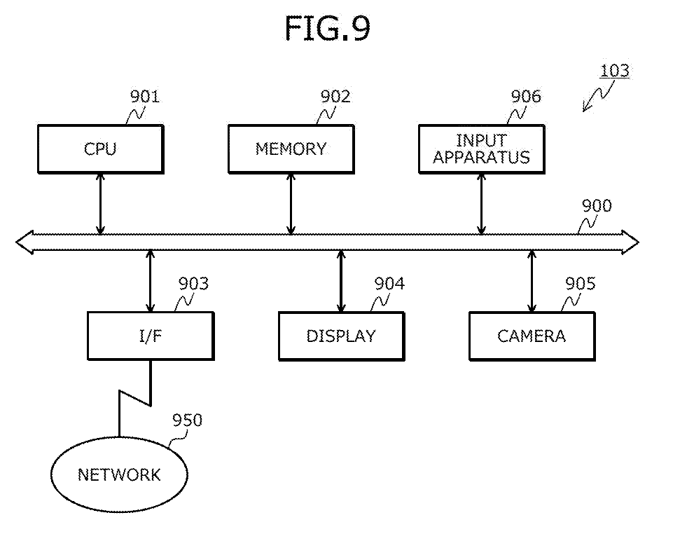

FIG. 9 is a block diagram of an example of a hardware configuration of the display apparatus according to the embodiment. In FIG. 9, the display apparatus 103 includes a CPU 901, a memory 902, an I/F 903, a display 904, a camera 905, and an input apparatus 906. The constituent units are connected by a bus 900.

The CPU 901 is responsible for the overall control of the display apparatus 103. For example, the memory 902 includes a ROM, a RAM, and a flash ROM. For example, the flash ROM or the ROM stores various programs, and the RAM is used as a work area of the CPU 901. The programs stored in the memory 902 are loaded on the CPU 901 and cause the CPU 901 to execute encoded processes.

The I/F 903 is connected through a communication line to a network 950 such as the Internet and is connected through the network 950 to the database 102 and other apparatuses including a server not depicted. The I/F 903 is responsible for interface between the network 950 and the inside of the apparatus and controls the input and output of data from other apparatuses.

The display 904 displays a cursor, an icon, or a tool box as well as data such as documents, images, and function information. For the display 904, for example, a liquid crystal display or an organic electronic Luminescence (EL) display may be adopted. The display 904 may be a head mounted display. This enables data to be presented in virtual reality.

The camera 905 is a device that takes still images or moving images. The camera may be used for taking pictures related to goods.

The input apparatus 906 has keys for inputting letters, numerals, various instructions, etc., and inputs data. The input apparatus 906 may be a keyboard, a pointing device, etc., or may be a touch panel type input pad, a numeric keypad, etc.

The display apparatus 103 may have various sensors, a hard disk drive (HDD), an SSD, etc. in addition to the constituent units described above.

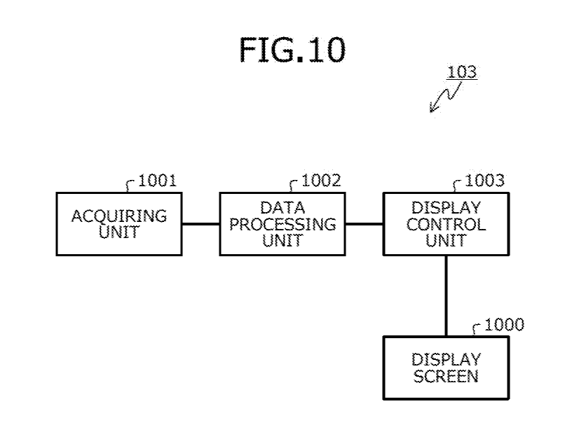

FIG. 10 is a block diagram of an example of a functional configuration of the display apparatus according to the embodiment. In FIG. 10, the display apparatus 103 includes a display screen 1000 as well as an acquiring unit 1001, a data processing unit 1002, and a display control unit 1003.

For example, a function of the display screen 1000 may be implemented by the display 904 depicted in FIG. 9, for example.

The acquiring unit 1001 receives input of position information regarding changing positions of the mobile body 110 moving by wind power, or for example, the GPS value described above. The acquiring unit 1001 also acquires state information regarding a state of the mobile body at each position, or for example, a detection value from the nine-axis sensor 202.

For example, functions of the acquiring unit 1001 may be implemented by causing the CPU 901 to execute a program stored in a storage apparatus such as the memory 902 depicted in FIG. 9 or by the I/F 903, the input apparatus 906, etc.

The data processing unit 1002 calculates the speed of the mobile unit 110 at each position based on the position information. The data processing unit 1002 calculates based on the position information, a running direction and a traveling direction (e.g., abeam, close-hauled, or quarter-lee) of the mobile body 110 relative to the wind direction, at each position.

The data processing unit 1002 detects a running start that is a transition from a non-planing state to a planing state based on speed. For example, the data processing unit 1002 detects a state in which a speed equal to or greater than a predetermined speed continues for a predetermined period to determine the state as a non-planning state and detects a state in which a speed equal to or greater than a predetermined speed continues for a predetermined period after the non-planning state to detect the state as the planing state.

The data processing unit 1002 detects the non-planning state, detects the planing state after the non-planing state, and calculates acceleration from a highest attained speed in an interval of the planing state. The data processing unit 1002 may evaluate the running start based on the calculated acceleration.

For example, functions of the data processing unit 1002 may be implemented by causing the CPU 901 to execute a program stored in a storage apparatus such as the memory 902 depicted in FIG. 9, for example.

The display control unit 1003 displays temporal changes in speed by a graph. The display control unit 1003 may display the temporal changes in speed and the traveling direction by a graph. The display control unit 1003 may display, by a graph, at least one of a highest speed and an average speed among speeds. For example, the graph may be a graph that uses a time period from a start time point and the speed at each time point in the time period as two parameters.

The display control unit 1003 may display a first mark indicating an arbitrary position on the graph and may display a second mark at a position on a movement locus of the mobile body 110 on a map such that the position is temporally synchronized with the position on the graph on which the first mark is displayed.

The display control unit 1003 may display state information temporally synchronized with the position on the graph on which the first mark is displayed. The state information may be information regarding the tilt of the mast 111 of the mobile body 110. The state information may be information regarding the rotation angle of the sail 113 of the mobile body 110.

The display control unit 1003 may automatically move the first mark along a time axis of the graph.

The display control unit 1003 may display information regarding the running start based on speed, running direction, and situation.

For example, functions of the display control unit 1003 may be implemented by causing the CPU 901 to execute a program stored in a storage apparatus such as the memory 902 depicted in FIG. 9, for example.

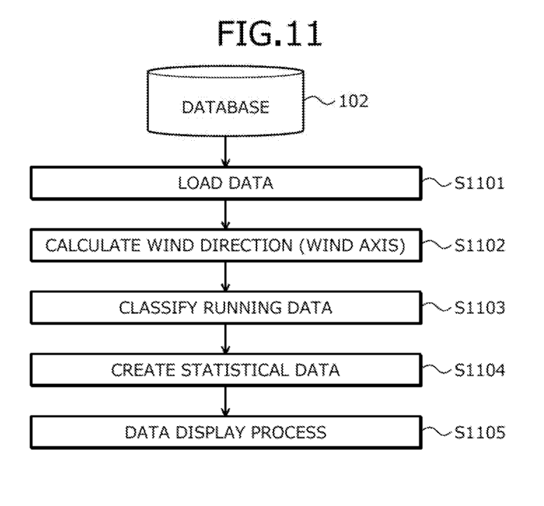

FIG. 11 is a flowchart of an example of a data display process procedure. In the flowchart depicted in FIG. 11, the display apparatus 103 first loads data from the database 102 (step S1101). The display apparatus 103 then calculates a wind direction (wind axis) based on the loaded data (step S1102).

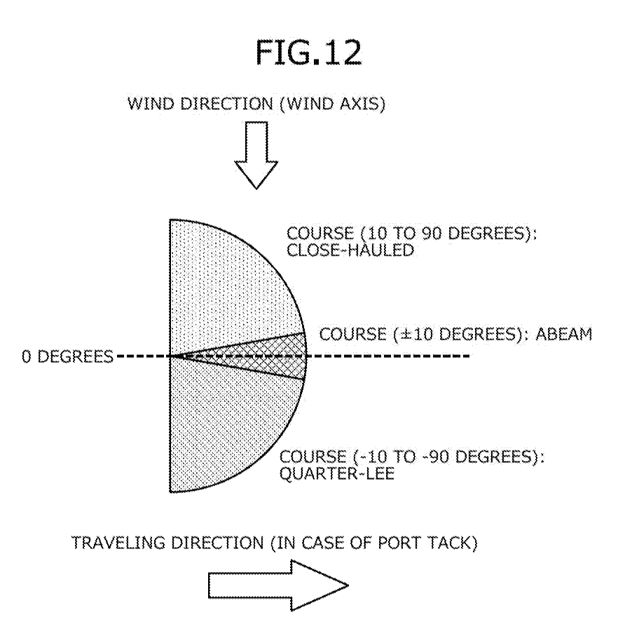

The display apparatus 103 classifies running data (step S1103). The display apparatus 103 sets a straight line orthogonal to the wind direction to zero degrees and classifies the data into three types from the “movement azimuth” of the GPS data, based on a judgment standard depicted in FIG. 12.

The display apparatus 103 creates statistical data (step S1104). The display apparatus 103 executes data statistical process, whereby a polar curve is displayed and all the GPS data of the same user is loaded and integrated. Subsequently, the display apparatus 103 calculates [highest speed, direction] and [various VMGs]. Velocity Made Good (VMG) is an effective speed and means a speed with respect to a desired direction (how far one is traveling in the desired direction). The display apparatus 103 also executes a jibe recognition process. A jibe is a turn under the wind.

Subsequently, the display apparatus 103 executes a data display process (step S1105), ending the series of operations.

FIG. 12 is an explanatory diagram of details of the classification of the running data. In FIG. 12, “abeam” is a course at ±10 degrees, i.e., running in a direction perpendicular to the wind; “close-hauled” is a course at 10° to 90°, i.e., running in a windward direction; and “quarter-lee” is a course at −10 degrees to −90 degrees, i.e., running in a leeward direction.

Additionally, two classifications are defined as “port tack”, which is the case of going in the rightward direction, and “starboard tack”, which is the case of going in the leftward direction, relative to the wind direction (wind axis). FIG. 12 depicts the case of “port tack”, and this is reversed left and right in the case of “starboard tack” and classified into three types as well.

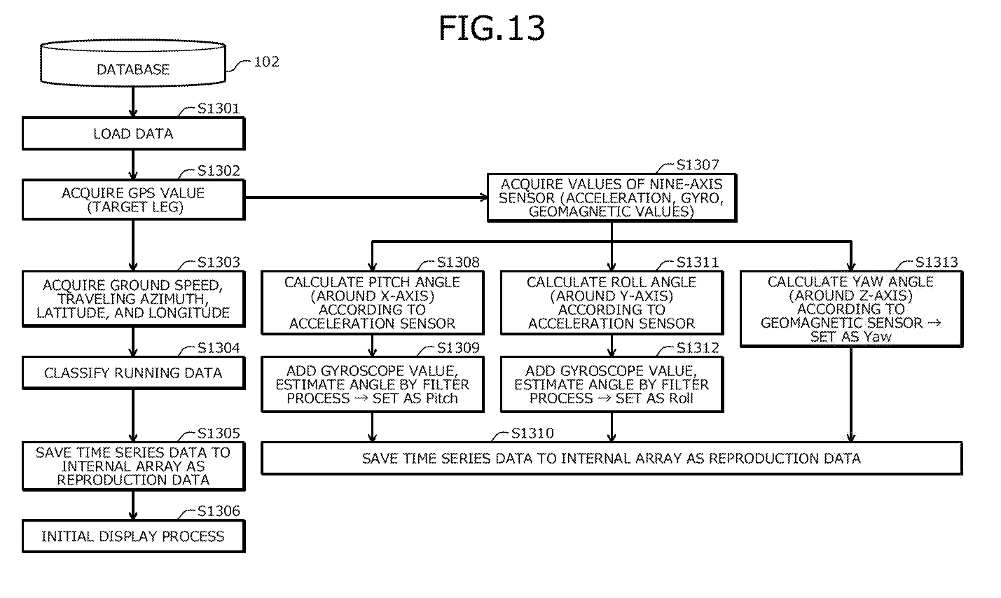

FIG. 13 is a flowchart of an example of an angle data calculation process procedure. In the flowchart depicted in FIG. 13, the display apparatus 103 first loads data from the database 102 (step S1301). The display apparatus 103 then acquires from the loaded data, the GPS value corresponding to a target leg (step S1302). Based on the acquired GPS value, the display apparatus 103 then acquires the ground speed, the traveling azimuth, the latitude, and the longitude (step S1303).

Subsequently, the display apparatus 103 classifies running data (step S1304). For example, based on the classification of the running data at step S1103 of the flowchart depicted in FIG. 11, the display apparatus 103 performs color coding according to the traveling direction.

The display apparatus 103 stores time series data to an internal array as reproduction data (step S1305). The display apparatus 103 executes an initial display process (step S1306). For example, the display apparatus 103 executes the process to connect plots of GPS point group data and consecutive points on a map with a line.

The display apparatus 103 acquires values of the nine-axis sensor 202 according to the GPS value for the target leg acquired at step S1302 (step S1307). The display apparatus 103 calculates a pitch angle that is an angle around the X-axis according to the acceleration sensor, among the acquired values of the nine-axis sensor 202 (step S1308).

Among the acquired values of the nine-axis sensor 202, the display apparatus 103 adds a gyroscope value from the gyro sensor, and estimates an angle by a filter process (step S1309). This angle is defined as the pitch angle. For example, the display apparatus 103 performs a process with a complementary filter, a linear Kalman filter, an unscented Kalman filter, etc. as the filter process.

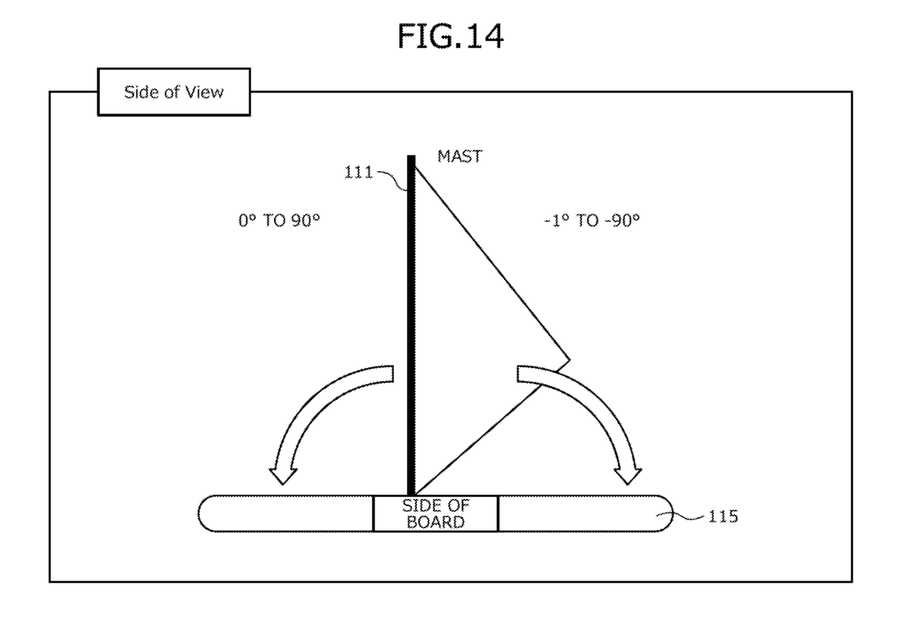

FIG. 14 is an explanatory view of details of the pitch angle calculation. FIG. 14 depicts a view of the sailboard 110 as seen from a side (Side of View). In FIG. 14, the pitch angle (Euler angle) is 0° when the mast 111 is perpendicular to the board unit 115, and a plus (0° to 90°) means a state in which the mast 111 is tilted forward, i.e., a tilt toward the nose side, from this state, while a minus (−1° to −90°) means a state in which the mast 111 is tilted backward, i.e., a tilt toward the tail side. This range is a range within which the pitch angle can be calculated.

The pitch angle can be calculated by equation (1).

Pitch angle=A TAN((ax)/SQRT(ay*ay+az*az)) (1)

ax: acceleration sensor value of the X-axis

ay: acceleration sensor value of the Y-axis

az: acceleration sensor value of the Z-axis

The display apparatus 103 calculates a roll angle that is an angle around the Y-axis according to the acceleration sensor, among the values of the nine-axis sensor 202 acquired at step S1307 (step S1311). Among the acquired values of the nine-axis sensor 202, the display apparatus 103 adds the gyroscope value from the gyro sensor, and estimates an angle by a filter process (step S1312). This angle is defined as the roll angle.

Similarly to the filter process used for estimating the roll angle, for example, the display apparatus 103 performs a process with a complementary filter, a linear Kalman filter, an unscented Kalman filter, etc. as the filter process.

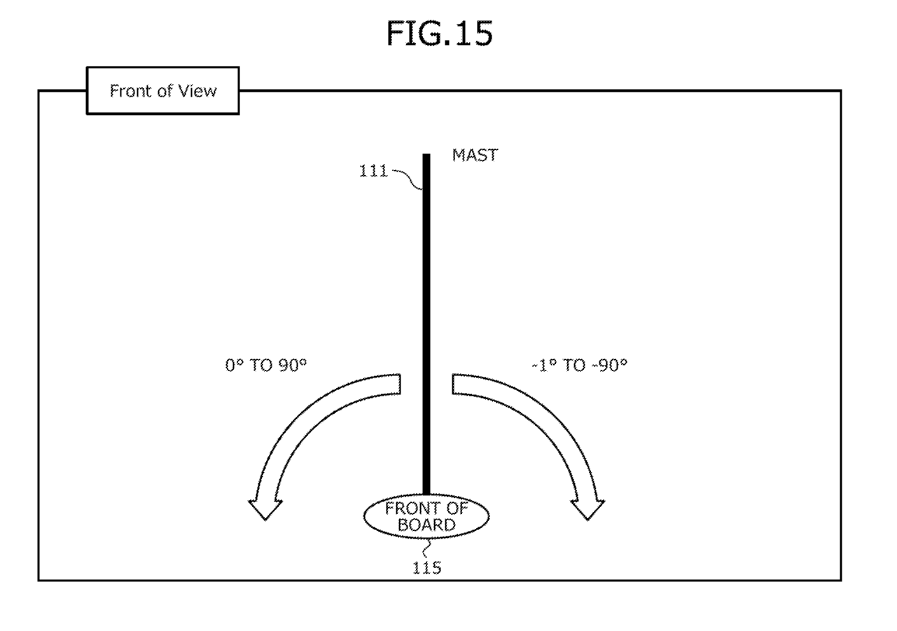

FIG. 15 is an explanatory view of details of the roll angle calculation. FIG. 15 depicts a view of the sailboard 110 as viewed from the front (nose side) (Front of View). In FIG. 15, the roll angle (Euler angle) is 0° when the mast 111 is perpendicular to the board unit 115, and a plus (0° to 90°) means a state in which the mast 111 is tilted toward the left side of the drawing, i.e., a tilt toward the left side of the board unit 115, from this state, while a minus (−1° to −90°) means a state in which the mast 111 is tilted toward the right side of the drawing, i.e., a tilt toward the right side of the board unit 115. This range is a range within which the roll angle may be calculated.

The roll angle can be calculated by equation (2).

Roll angle=A TAN((ay)/SQRT(ax*ax+az*az)) (2)

The display apparatus 103 calculates a yaw angle that is an angle around the Z axis according to the geomagnetic sensor, among the values of the nine-axis sensor 202 acquired at step S1307 (step S1313).

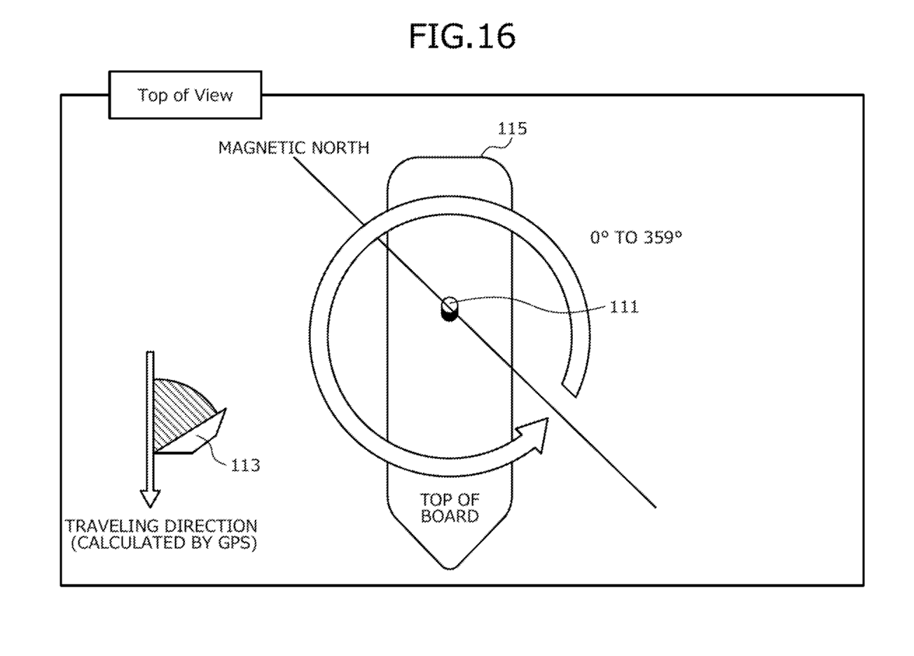

FIG. 16 is an explanatory diagram of details of the yaw angle calculation. FIG. 16 depicts a view of the sailboard 110 as viewed from above (Top of View). In FIG. 16, the yaw angle (Euler angle) is a rotation angle of the sail 113 based on the magnetic north around the mast 111. The angle is 0° at a position where the mast 111 side of the sail 113 faces the magnetic north, i.e., the position where the boom end side faces in a direction opposite to the magnetic north, and the angle may be calculated within a counterclockwise range from 0° to 359°.

Since the traveling direction may be calculated from the GPS, the rotation angle of the sail 113 may also be calculated by gyro correction using a low-pass filter process, based on the value of the geomagnetic sensor.

The yaw angle (Yaw) may be calculated by equations (3) to (5).

magX: geomagnetic sensor value of the X-axis

magY: geomagnetic sensor value of the Y-axis

Yaw=a tan 2(magX,magY);

if(Yaw<0)Yaw+=2*PI,

if(Yaw>2*PI)Yaw−=2*PI; (3)

Yaw=Yaw*180/M_PI; (4)
//adjust the magnetic deflection angle in the case of west deflection (Japan) Yaw=Yaw+6.6; //magnetic deflection angle of 6.6 degrees

if(Yaw>360.0)Yaw=Yaw−360.0; (5)

Using the pitch angle estimated at step S1309, the roll angle estimated at step S1312, and the yaw angle calculated at step S1313 as the reproduction data, the display apparatus 103 stores time series data to the internal array (step S1310), ending the series of operations.

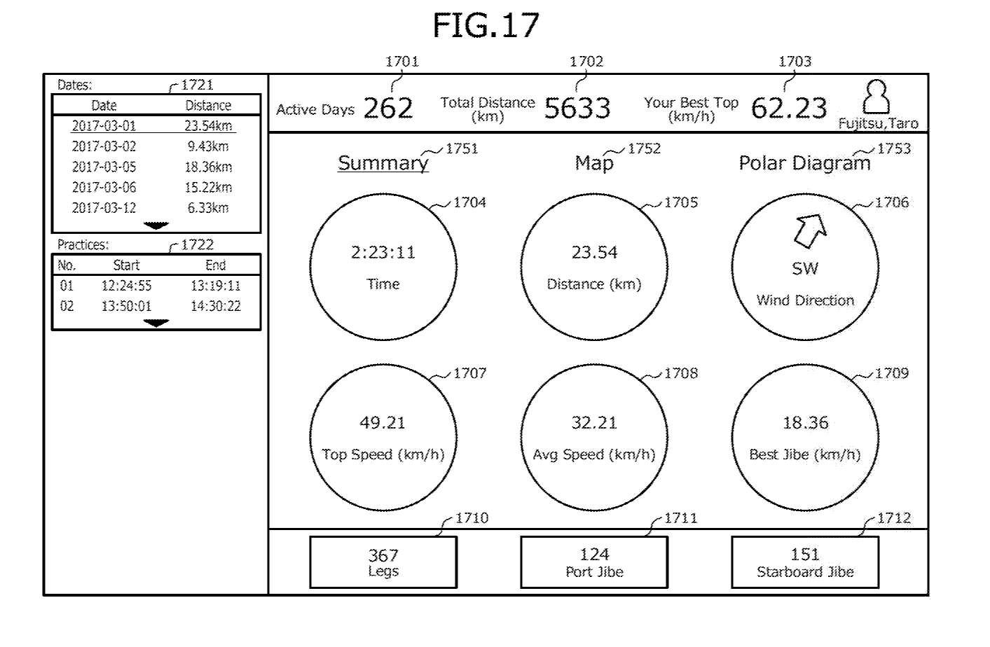

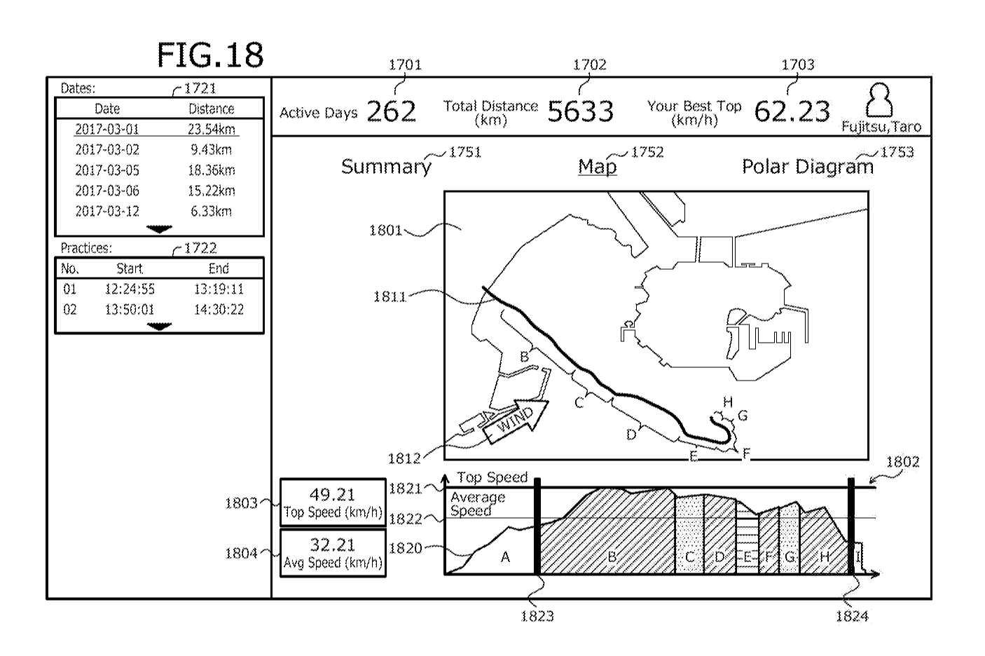

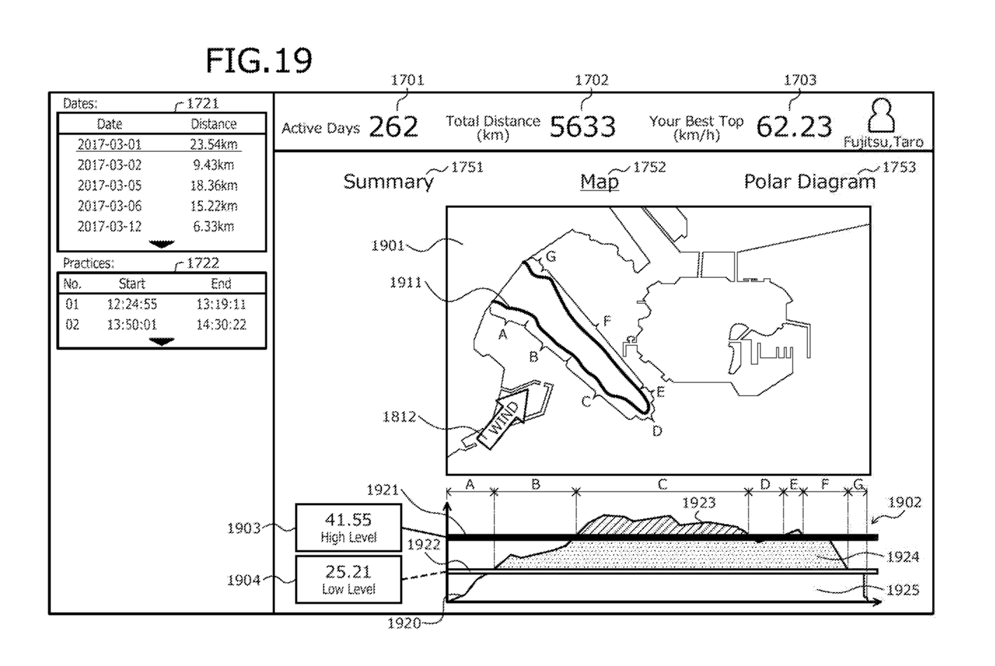

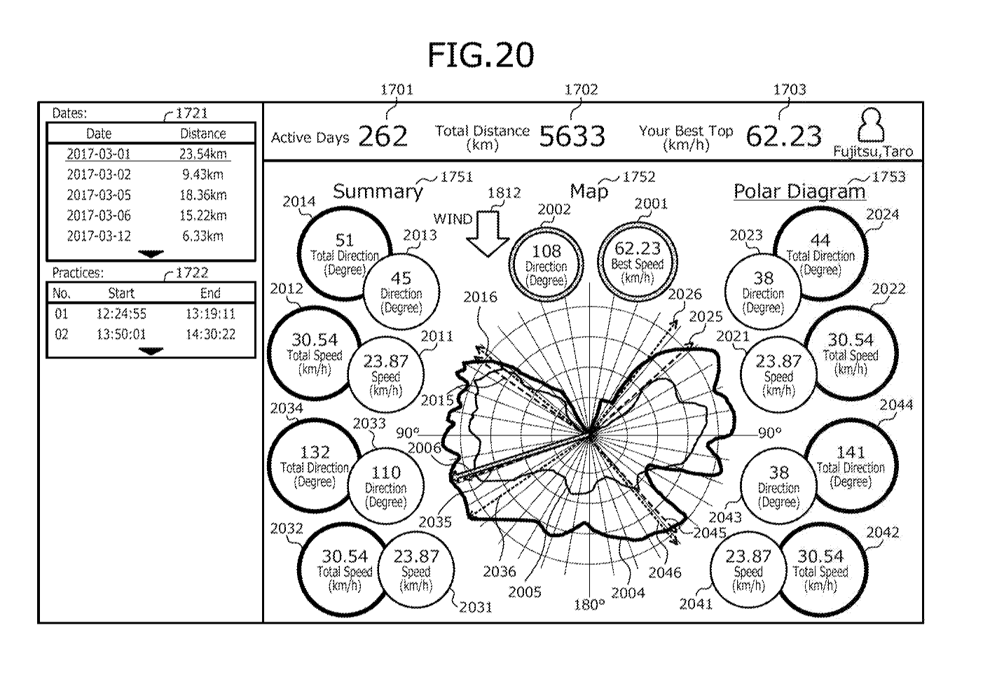

FIGS. 17, 18, 19, 20, and 21 are explanatory views of contents of data display. FIG. 17 depicts an example of a summary display, FIGS. 18 and 19 depict an example of a map display, and FIG. 20 depicts an example of a polar diagram display.

FIG. 17 depicts the contents of the summary. In FIG. 17, “Active Days” 1701, “Total Distance” 1702, and “Your Best Top” 1703 are displayed in an upper field of a display screen.

The “Active Days” 1701 indicates the cumulative number of days of the user's sailing (practice) and the indicated number of days is “262 (days)”. The “Total Distance” 1702 indicates the cumulative distance of the user's sailing (riding on the sailboard 110) and the indicated distance is “5633 (km)”. The “Your Best Top” 1703 indicates the highest speed during the period of the cumulative number of days (distance) of the user's sailing and the indicated speed is “62.23 (km/h)” (62.23 km per hour).

In FIG. 17, “Time” 1704, “Distance” 1705, and “Wind Direction” 1706 are displayed from the left in an upper row in a main field of the display screen.

The “Time” 1704 indicates a time period for one day, i.e., the time period from the pressing of a sensor recording start button to the pressing of a recording end button, and the indicated time period is “2:23:11” (2 hours 23 minutes 11 seconds).

The “Distance” 1705 indicates a total distance of the user's sailing for one day, i.e., a distance sailed from the pressing of the sensor recording start button to the pressing of the recording end button, and the indicated distance is “23.54 (km)”. For the total distance, a value calculated from the GPS value may be used.

The “Wind Direction” 1706 indicates a wind direction predicted from the running data and is depicted as “SW” (southwest wind) and an arrow pointing in an upper right direction indicating southwest. For the wind direction, the direction calculated at step S1102 of the flowchart depicted in FIG. 11 may be used.

As described above, the upper row depicts objective information of sailing history not directly related to a sailing technique.

In FIG. 17, “Top Speed” 1707, “Avg Speed” 1708, and “Best Jibe” 1709 are displayed from the left in the lower row in the main field of the display screen. The “Top Speed” 1707 indicates the highest speed recorded in the one-day data and the indicated speed is “49.21 (km/h)” (49.21 km per hour). The “Avg Speed” 1708 indicates the average speed in the one-day data (excluding the land waiting time) and the indicated speed is “32.21 (km/h)” (32.21 km per hour).

The “Best Jibe” 1709 indicates the maximum escape speed in the jibes recorded in the one-day data, and the indicated speed is “18.36 (km/h)” (18.36 km per hour).

In FIG. 17, “Legs” 1710, “Port Jibe” 1711, and “Starboard Jibe” 1712 are displayed in a lower field under the main field of the display screen.

The “Legs” 1710 indicate the number of (a count of) Legs performed in the one-day data, and the indicated number is “367 (legs)”. The “Port Jibe” 1711 indicates the number of jibes from a port tack (a way of sailing while receiving wind from the left side of the board unit 115 with the left hand and the left foot in front), and the indicated number is “124 (times)”. The “Starboard Jibe” 1712 indicates the number of jibes from a starboard tack (a way of sailing while receiving wind from the right side of the board unit 115, contrary to the port tack, with the right hand and the right foot in front), and the indicated number is “151 (times)”.

The main field of the display screen displays the six items surrounded by circles. Since all the items have analog values, this enables intuitive comprehension of images of such analog values. The lower field of the display screen displays the three items surrounded by rectangles and, since all these items are digital values, this enables intuitive comprehension of images of such digital values. In this way, the displayed items may be changed in design to allow a user to intuitively and sensorially comprehend the data.

A left field of the display screen displays a list 1721 of summaries of the one-day data for each date. In this list 1721, dates (Date) and the total distance (Distance) of the user's sailing for one day are arranged in order of date. This list 1721 can be sorted and rearranged in ascending or descending order of the date (Date), or in ascending or descending order of the total distance (Distance). The one-day data may be displayed by selecting from the list, a summary (date) to be displayed.

In FIG. 17, displayed in descending order of the date (Date), “2017-03-01 23.54 km” at the top has been selected and is highlighted in the display, and it can be seen that the time “2:23:11” of the “Time” 1704 and the distance “23.54 (km)” of the “Distance” 1705 agree.

A list 1722 of summaries of multiple Practices in the one-day data selected in the list 1721 is displayed on the lower side of the list 1721 of summaries of the one-day data. The list 1722 displays a serial number (“No.”) for each Practice, the start time (“Start”) of the Practice, and the end time (“End”) of the Practice. The data of the corresponding Practice may be displayed by selecting from the list, a summary (Practice) to be displayed.

In FIG. 17, no summary (Practice) is selected and the display is not changed. When any of the summaries (Practices) is selected, the summary is highlighted, and the summary data of the items 1704 to 1712 in the main field and the lower field is accordingly narrowed down and displayed.

In FIG. 17, on the upper side of the main field of the display screen, screen switching buttons of “Summary” 1751, “Map” 1752, and “Polar Diagram” 1753 are provided. The “Summary” 1751 is the summary screen depicted in FIG. 17, the “Map” 1752 is a display screen that uses a map depicted in FIGS. 18 and 19, and the “Polar Diagram” 1753 is a display screen that uses a polar diagram depicted in FIG. 20.

Since the summary is displayed in FIG. 17, a form (including color) of display of “Summary” 1751 is different from the “Map” 1752 and the “Polar Diagram” 1753. By clicking or touching the positions of display of the “Map” 1752 and the “Polar Diagram” 1753 with a pointing device etc., or with a finger etc., the screen may be switched easily to the display screen depicted in FIGS. 18 and 19 or the display screen depicted in FIG. 20, respectively.

FIG. 18 depicts the contents of the map. FIG. 18 mainly depicts a map part 1801 along with a speed display part 1802 thereunder that displays a change in speed over time by a line graph 1820.

The “Active Days” 1701, the “Total Distance” 1702, and the “Your Best Top” 1703 in the upper field of the display screen display the same contents as those of FIG. 17. The list 1721 of summaries of one-day data in the left field of the display screen and the list 1722 of summaries of multiple Practices in the one-day data are also the same as those depicted in FIG. 7.

The screen switching buttons of the “Summary” 1751, the “Map” 1752, and the “Polar Diagram” 1753 on the upper side of the main field of the display screen are the same contents as those depicted in FIG. 17. In FIG. 18, since the map is displayed, the display form (color) of the “Map” 1752 is different from the “Summary” 1751 and the “Polar Diagram” 1753.

In FIG. 18, a locus 1811 of movement (sailing) of the sailboard 110 is displayed in the map part 1801. An arrow 1812 indicating the wind direction is also displayed.

In FIG. 18, in the speed display part 1802, the line graph 1820 indicating the speed is displayed, where the horizontal axis (X-axis) represents time and the vertical axis (Y-axis) represents speed. The vertical axis (Y-axis) is associated with two lines, which are a line (Top Speed) 1821 and a line (Average Speed) 1822 parallel to the horizontal axis (X-axis). The line (Top Speed) 1821 is a line indicating the highest speed. The line (Average Speed) 1822 is a line indicating the average speed. The highest speed and the average speed are displayed as the “Top Speed” 1803 and the “Avg Speed” 1804, respectively.

The horizontal axis (X-axis) is associated with two lines, which are a line 1823 indicating the start time of the display on the map and a line 1824 indicating the end time of the display on the map parallel to the vertical axis (Y-axis). Only a section between the two lines 1823 and 1824 is displayed as the locus in the map part 1801.

The line graph 1820 is classified into nine regions A to I. The region A is before the line 1823 and therefore not displayed on the map. Thus, the region is not color-coded or is indicated by color (e.g., gray) for differentiation from the other color-coded regions.

The regions B, D, F, and H indicate abeam. The regions of abeam may be colored in red, for example. The regions C and G indicate quarter-lee. The regions of the quarter-lee may be colored in blue, for example. The region E indicates close-hauled. The region of close-hauled can be colored in yellow, for example.

The region I is after the line 1824 and therefore, not displayed as the locus 1811 in the map part 1801. Thus, similar to the region A, the region is not color-coded or is indicated by a color such as gray, for example.

In this way, the regions B to H of the line graph 1820 of the speed display part 1802 are in the order of the region B: “abeam (red)”→the region C: “quarter-lee (blue)”→the region D: “abeam (red)”→the region E: “close-hauled (yellow)”→the region F: “abeam (red)”→the region G: “quarter-lee (blue)”→the region H: “abeam (red)”, and may be displayed in a color-coded manner according to a running type.

The locus 1811 of the movement (sailing) of the sailboard 110 is colored and displayed in the colors of the coloring in the speed display part 1802. As depicted in FIG. 18, the locus 1811 is colored in a section B in red, a section C in blue, a section D in red, a section E in yellow, a section F in red, a section G in blue, and a section H in red, so that the same colors are used as the regions B to H of the line graph 1820 of the speed display part 1802. As a result, the sailing types may be displayed separately by color.

With this configuration, the visuality of data may be improved. Therefore, the locus 1811 of the map part 1801 and the line graph 1820 of the speed display part 1802 are synchronized so that the speed at each position on the locus 1811 may be easily and intuitively comprehended, and what type of sailing was being performed may be instantaneously recognized. Therefore, how the running was being performed may be clearly comprehended and what type of sailing was being performed (close-hauled, abeam, quarter-lee, etc.) may be recognized.

In FIG. 19, as in FIG. 18, a map part 1901 and a speed display part 1902 are displayed. As in FIG. 18, the speed display part 1902 displays a line graph 1920 indicating changes in the speed, where the horizontal axis (X-axis) represents time and the vertical axis (Y-axis) represents speed. The vertical axis (Y-axis) is associated with two lines, which are a line (High Level) 1921 and a line (Low Level) 1922, parallel to the horizontal axis (X-axis).

The line (High Level) 1921 is a line indicating an upper limit speed. The line (Low Level) 1922 is a line indicating a lower limit speed. The upper limit speed “41.55 (km/h)” and the lower limit speed “25.21 (km/h)” are displayed in “High Level” 1903 and “Low Level” 1904, respectively.

The line graph 1920 is divided by the line (High Level) 1921 and the line (Low Level) 1922 into three regions (regions 1923, 1924, 1925). A region 1923 of speeds equal to or faster than the upper limit speed is depicted in red, a region 1924 of speeds less than the upper limit speed and equal to or faster the lower limit speed is depicted in blue, and the region 1925 of speeds slower than the lower limit speed is depicted in gray.

In FIG. 19, sections A to G are set based on intersections between the line graph 1920 and the lines 1921, 1922. For example, the sections A and G are the region 1925, the sections B, D, and F are the region 1924, and the sections C and E are the region 1923.

The locus 1911 of the map unit 1901 is color-coded for each of the sections A to G in synchronization with the color-coding of the speed display part 1902. The coloring is performed as follows: “section A: gray”→“section B: blue”→“section C: red”→“section D: blue”→“section E: red”→“section F: blue”→“section G: gray”.

With this configuration, as in FIG. 18, the locus 1911 of the map part 1901 is synchronized with the line graph 1920 of the speed display part 1902, and the speed at each position on the locus 1911 may be easily and intuitively comprehended.

FIG. 20 is an explanatory view of contents of a polar diagram. In FIG. 20, a polar diagram is displayed at a center with respect to a wind direction (WIND) indicated by the arrow 1812, and “Best Speed” 2001 and “Direction” 2002 are displayed above the center. The “Best Speed” 2001 indicates a user's highest speed in the past, and the highest speed is indicated to be “62.23 (km/h)”. The “Direction” 2002 indicates the angle at the time of the highest speed in the past, and the angle is indicated to be “108(°)”.

In a periphery of the polar diagram, four circular displays indicating numerical values are displayed in respective regions on the upper left, upper right, lower left, and lower right sides.

On the upper left side of the drawing, upwind “Speed” 2011, “Total Speed” 2012, “Direction” 2013, and “Total Direction” 2014 of the upwind VMG starboard tack of the selected day are displayed.

The “Speed” 2011 indicates the upwind speed of the upwind VMG starboard tack of the day, and the speed is indicated to be “23.87 (km/h)”. The “Total Speed” 2012 indicates the cumulative upwind speed of the upwind VMG starboard tack, and the speed is indicated to be “30.54 (km/h)”.

The “Direction” 2013 indicates the upwind angle of the upwind VMG starboard tack of the day, and the angle is indicated to be “45(°)”. The “Total Direction” 2014 indicates the cumulative upward angle of the upwind VMG starboard tack, and the angle is indicated to be “51(°)”.

As depicted in FIG. 20, the circle indicating the cumulative value is displayed to be larger than and on the outer side of the value of the selected day, thereby giving an image that the value of the selected day is a portion of the cumulative value so that one may intuitively comprehend which is the value of the selected date and which is the cumulative value. Furthermore, this may be made clearer by changing the color of the border of the circle.

On the upper right side of the drawing, upwind “Speed” 2021, “Total Speed” 2022, “Direction” 2023, and “Total Direction” 2024 of the upwind VMG port tack of the selected day are displayed.

On the lower left side of the drawing, upwind “Speed” 2031, “Total Speed” 2032, “Direction” 2033, and “Total Direction” 2034 of the leeward VMG starboard tack on the selected day are displayed.

On the lower right side of the drawing, upwind “Speed” 2041, “Total Speed” 2042, “Direction” 2043, and “Total Direction” 2044 of the leeward VMG port tack of the selected day are displayed.

A line 2004 indicates the polar curve of the selected day, and a line 2005 indicates the cumulative polar curve. An arrow 2006 indicates the vector of the highest speed in the past. An arrow 2015 indicates a vector of the upwind VMG starboard tack of the selected day, and an arrow 2016 depicts the cumulative vector of the upwind VMG starboard tack. The speed is indicated by the length of the arrows, and the angle is indicated by the direction pointed by the arrows.

Similarly, an arrow 2025 indicates the vector of the upwind VMG port tack of the selected day and an arrow 2026 indicates the cumulative vector of the upwind VMG port tack. An arrow 2035 indicates the vector of the leeward VMG starboard tack of the selected day, and an arrow 2036 indicates the cumulative vector of the leeward VMG starboard tack. An arrow 2045 indicates the vector of the leeward VMG port tack on the selected day and an arrow 2046 indicates the cumulative vector of the leeward VMG port tack.

This can be used as a reference for comprehending the characteristics (habit, strong/weak points) of user's riding with respect to the wind direction.

“Active Days” 1701, “Total Distance” 1702, and “Your Best Top” 1703 in the upper field of the display screen display the same contents as in FIGS. 17 to 19. The list 1721 of summaries of one-day data in the left field of the display screen and the list 1722 of summaries of multiple Practices in the one-day data are also the same as those in FIGS. 17 to 19.

The screen switching buttons of the “Summary” 1751, the “Map” 1752, and the “Polar Diagram” 1753 on the upper side of the main field of the display screen are the same contents as in FIGS. 17 to 19. In FIG. 20, since the polar diagram is displayed, the form (color) of display of the “Polar Diagram” 1753 is different from the “Summary” 1751 and the “Map” 1752.

In this way, the polar curve may be drawn according to the acquired information (board speed, direction) from GPS, and what way of riding was being performed with what kind of tool at that time may be recorded.

As a result, although only the highest speed and the average speed may be compared in conventional GPS products, the sailing ability may be evaluated visually and objectively through visualization. Therefore, a factor of improvement may be comprehended. For example, the VMG and the highest speed may be improved under the same condition of the tool/wind speed. Additionally, it may be confirmed that the way of riding has improved. For example, the VMG and the highest speed may be improved in the same way of riding/at the same wind speed. Moreover, it may be confirmed that an improvement is achieved with a tool.

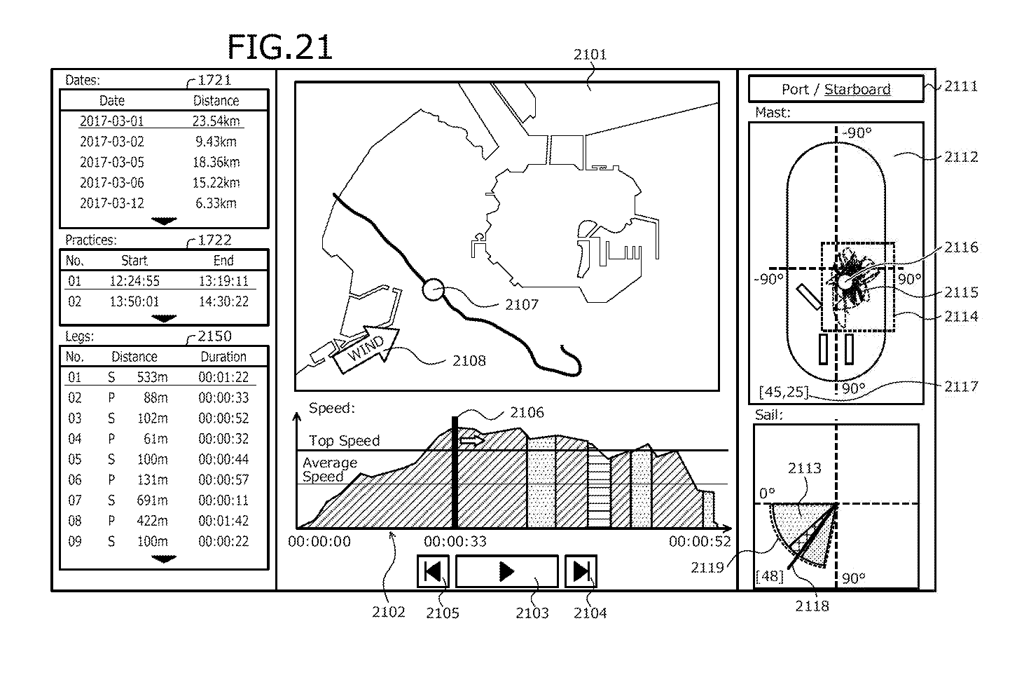

FIG. 21 depicts an application example of the display screen depicted in FIG. 18, depicting the display contents when one leg is selected. In FIG. 21, the left field of the display screen displays the list 1721 of “Dates” and the list 1722 of “Practices” as well as a list 2150 of “Legs”. In this figure, since a practice is selected, the list of multiple legs in the selected practice is displayed. This screen is displayed by selecting one leg therefrom. In FIG. 21, the leg of No. 1 is selected. In the “Legs” 2150, “S” indicates the starboard tack, and “P” indicates the port tack.

In FIG. 21, a speed display part 2102 displays changes in speed over time for the selected leg as a line graph. On the lower side of the speed display part 2102, a reproduction button 2103, a fast-forward button 2104, and a rewind button 2105 are displayed. In the speed display part 2102, a reproduction position display bar 2106 is displayed. A time (“00:00:33”) at the reproduction position is displayed under the reproduction position display bar 2106.

When the reproduction button 2103 is pressed, the reproduction position display bar 2106 automatically moves from the left to the right. The movement speed may be coincident with the recorded time and may be able to be doubled or slowed down. When the reproduction button 2103 is pressed again during a reproduction operation, the reproduction may be temporarily stopped (paused). In this way, a reproduction instruction may be made similarly as with operation of a DVD player, for example.

As the reproduction position display bar 2106 moves, a point 2107 of a map part 2101 moves in synchronization with the reproduction position. Therefore, the point 2107 indicates the position of the sailboard 110 at the time (“00:00:33”) in the reproduction position. By using the same color (e.g., green) for the reproduction position display bar 2106 and the point 2107, the feeling of synchronization may further be increased.

In this way, the displayed log may be reproduced. Since the automatic reproduction may be performed, the user only needs to press the reproduction button 2103 without a need for the other operations and therefore, may concentrate on comprehension of display contents (tracing of running) while having an image of performing actual running (feeling the wind in the wind direction indicated by the arrow 2108).

On the right field of the display screen, “Port/Starboard” 2111, a mast state display part 2112, and a sail state display part 2113 are displayed. The “Port/Starboard” 2111 displays a type of the running data, i.e., the port tack or the starboard tack. In FIG. 21, it can be seen that the type is the starboard tack.

The mast state display part 2112 simulates a state of a tilt of the mast 111 as viewed from above the sailboard 110. A frame 2114 depicts a range of swinging of the mast 111. As a result, the swinging may be confirmed as an extent, i.e., an area. The shape of the frame is not limited to a rectangle and may be an ellipse, etc. The range of the swinging may be displayed as a numerical value (e.g., a maximum value and a minimum value of the swinging). Therefore, it is intuitively understood that the stability is higher when the range is narrower.

A line 2115 indicates a locus of movement of a tip portion of the mast 111 in the selected leg. A point 2116 indicates a tip position of the mast 111 synchronized with the reproduction position associated with the movement of the reproduction position display bar 2106. Since the staying position of the mast 111 is displayed in a superimposed manner, the color becomes darker as the frequency increases. The locus 2115 may be color-coded as in the locus on the map 2101. The current state may be represented by a numerical value ([45, 25] 2117).

Therefore, the display position of the point 2116 changes as the reproduction position display bar 2106 moves. Therefore, a relationship between the speed and the position of the mast 111 may be easily and reliably comprehended. Thus, one may easily know where the mast 111 was located when the highest speed was attained.

The sail state display part 2113 simulates a state of pivoting of the sail 113 as viewed from above the sailboard 110. In the sail state display part 2113, the direction of the sail 113 is displayed as a line 2118 radially extended from the center. The line 2118 indicates the pivoting position of the sail 113 synchronized with the reproduction position associated with the movement of the reproduction position display bar 2106. Since the staying position of the sail 113 is displayed in a superimposed manner, the color becomes darker as the frequency increases.

A fan-shaped frame 2119 indicates a range of pivoting of the sail 113. The locus 2115 may be color-coded as in the locus on the map 2101. The angle of the sail 113 may be indicated by a numerical value ([48(°)]).

In this way, since the mast state display part 2112 and the sail state display part 2113 may be confirmed at the same time in a time series, the behavior of the mast 111 and the sail 113 in the leg may be accurately comprehended. The relationship between the speed and the behavior of the mast 111/the sail 113 may also be understood.

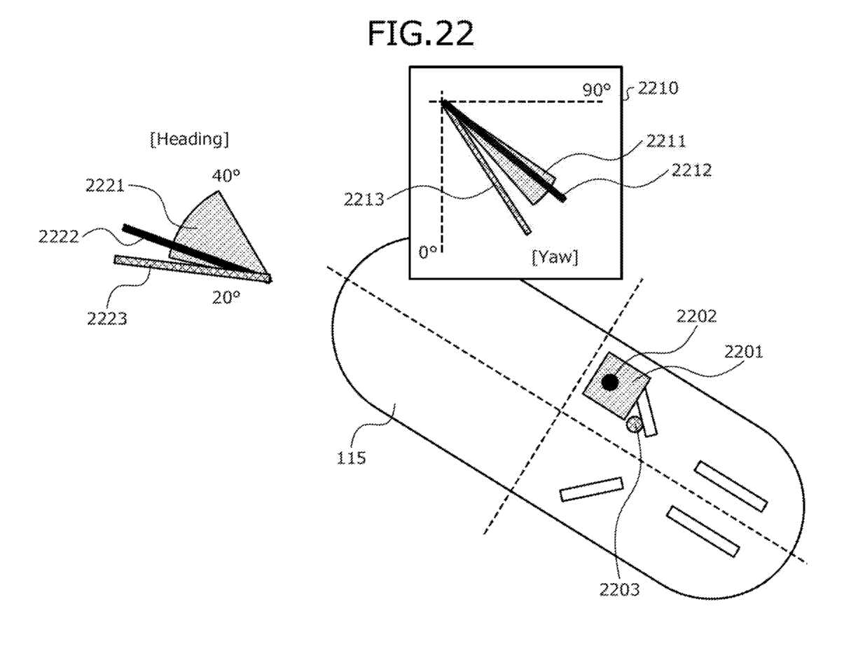

Details of real-time coaching will be described. FIG. 22 is an explanatory diagram of details of acceptance criteria. In FIG. 22, the real-time coaching is performed by determining whether a sailing form of a rider of the sailboard 110 satisfies the acceptance criteria based on the information acquired by the sensor 101 and notifying the rider of the result of the determination.

Whether the sailing form of the rider satisfies the acceptance criteria is determined based on the state information regarding the state of the sailboard 110 at each changing position of the sailboard 110 that moves by wind power. For example, the state information is information regarding the tilt of the mast 111, i.e., the pitch angle and the roll angle of the mast 111. The state information may be information regarding the rotation angle of the sail 113, i.e., the yaw angle of the sail 113. The state information may be a running direction of the sailboard 110 relative to the wind direction at each position, i.e., a heading angle of the sailboard 110 (the board unit 115).

In the real-time coaching, it is determined whether the acceptance criteria are satisfied in terms of all the pieces of the state information of the pitch angle and the roll angle of the mast 111, the yaw angle of the sail 113, and the heading angle of the sailboard 110. The determination on whether the acceptance criteria are satisfied may be made selectively for any one or more pieces of the state information.

In this case, a piece of the state information subjected to the determination may be set arbitrarily by the rider or may be set without an operation by the rider based on information, etc. acquired by the sensor 101 in the past. For example, the determination may be intensively made on a piece of the state information by which a weak point of the rider may be determined.

Whether the sailing form of the rider satisfies the acceptance criteria is determined based on whether the respective states of the pitch angle and the roll angle of the mast 111, the yaw angle of the sail 113, and the heading angle of the sailboard 110 fall within acceptable reference ranges 2201, 2211, 2221.

The acceptable reference ranges 2201, 2211, 2221 are set correspondingly to the pitch angle/the roll angle, the yaw angle, and the heading angle, respectively. The acceptable reference ranges 2201, 2211, 2221 are set based on an ideal sailing form. The ideal sailing form is indicated according to past Practice data of an experienced person, for example. The Practice data indicating the ideal sailing form is acquired from data associated with a User ID of a rider selected as the experienced person by a user of the sailing training support system 100, from the data stored in the database 102. Although the acceptable reference range 2201 is depicted as a rectangle in FIG. 22, the present invention is not limited thereto. The acceptable reference range 2201 may be a circle, an ellipse, or a range having other shapes.

The acceptable reference range 2201 of the pitch angle and the roll angle of the mast 111 is set based on a positional relationship of the joint 112 and the tip position of the mast 111, in a horizontal plane, for example. In the horizontal plane, the position of the joint 112 is positioned within the acceptable reference range 2201. While the mast 111 is vertically standing, the position of the joint 112 and the tip position of the mast 111 overlap in the horizontal plane.

When the tip position of the mast 111 in the horizontal plane is at a position denoted by reference numeral 2202, i.e., within the acceptable reference range 2201, the pitch angle and the roll angle of the mast 111 are in an angular range satisfying the acceptance criteria. On the other hand, when the pitch angle and the roll angle of the mast 111 are significantly tilted to deviate from the angular range satisfying the acceptance criteria, the position of the leading end of the mast 111 in the horizontal plane is at a position denoted by reference numeral 2203, i.e., out of the acceptable reference range 2201.

The acceptable reference range 2201 may be set for each type of training, i.e., for each content of the real-time coaching. For example, the acceptable reference range 2201 differs depending on whether the purpose of the real-time coaching is an improvement in the highest speed or an improvement in evaluation value of a jibe, for example.

In a frame denoted by reference numeral 2210, the acceptance criteria of the yaw angle of the sail 113 are depicted. The acceptable reference range 2211 of the yaw angle of the sail 113 is set based on the wind direction of the actual blowing wind, for example. The sail 113 receives the actual blowing wind and a wind due to traveling caused by the sailboard 110 moving by receiving the actual blowing wind. The wind direction of the actual blowing wind may be calculated based on the GPS value and the value of the nine-axis sensor 202 and may be calculated based on the position information at each time point and the yaw angle of the sail 113, for example. The running speed and a point of sail of the sailboard 110 may be calculated based on the position information at each time point.

If the yaw angle of the sail 113 is too small or too large, an escape of the wind leads to a reduction in power, whereby the speed decreases. In the real-time coaching, whether the yaw angle satisfies the acceptance criteria is determined by determining whether the actual yaw angle specified based on the value of the nine-axis sensor 202 (geomagnetic sensor) is within in the acceptable reference range 2211.

When the yaw angle of the sail 113 is at the position denoted by reference numeral 2212, i.e., within the acceptable reference range 2211, it is determined that the yaw angle is within the angle range satisfying the acceptance criteria. On the other hand, when the yaw angle of the sail 113 is out of the acceptable reference range 2211 as indicated by reference numeral 2213, it is determined that the yaw angle does not satisfy the acceptance criteria.

The acceptable reference range 2211 of the yaw angle may be set for each type of training, i.e., for each content of the real-time coaching. For example, the acceptable reference range 2211 differs depending on whether the purpose of the real-time coaching is an improvement in the highest speed or to arrive at a specified destination (goal) through a shortest route, for example.

The acceptable reference range 2211 differs depending on the conditions such as the direction of the actual blowing wind even though the purpose of the real-time coaching is the same. FIG. 22 depicts a determination example of real-time coaching related to an improvement in running speed of upwind running that is the traveling in the windward direction.

The heading angle of the sailboard 110, i.e., the point of sail of the sailboard 110 relative to the wind direction, is calculated based on the position information of the sailboard 110 changing as the sailboard moves by wind power, for example, the GPS value described above. The point of sail indicates the traveling direction of the sailboard 110 relative to the wind direction rather than the running direction on the map and therefore, changes according to a change in the wind direction, etc.

The acceptable reference range 2221 of the heading angle is set based on the content of the real-time coaching, for example. For example, in the case of the real-time coaching for arriving at a specified destination (goal) through a shortest route, the acceptable reference range 2221 is set to a range of the heading angle enabling arrival at a specified destination (goal) through a shortest route. For example, when the contents of the real-time coaching are improvement in the highest speed, the acceptable reference range 2221 of the heading angle is set to a range of the heading angle in which the speed becomes the highest in consideration of the wind direction of the actual blowing wind.

If the sailboard 110 is running in the direction according to the contents of the real-time coaching, the heading angle falls within the acceptable reference range 2221 as indicated by reference numeral 2222. On the other hand, if the sailboard 110 is not running in the direction according to the contents of the real-time coaching, the heading angle is out of the acceptable reference range 2221 as indicated by reference numeral 2223.

As described above, a notification apparatus according to the real-time coaching has a control unit that acquires the position information regarding the changing positions of the mobile body 110 that moves by wind power, the control unit further acquiring the state information regarding the state of the mobile body 110 at each position, determining whether this state is within a predefined range, and notifying the rider of the mobile body of a result of the determination. Functions of the control unit may be implemented by the sensor 101 and the display unit 104.

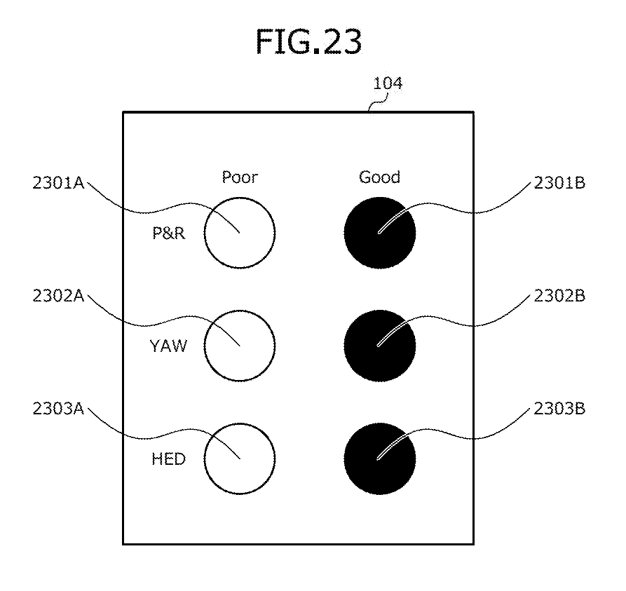

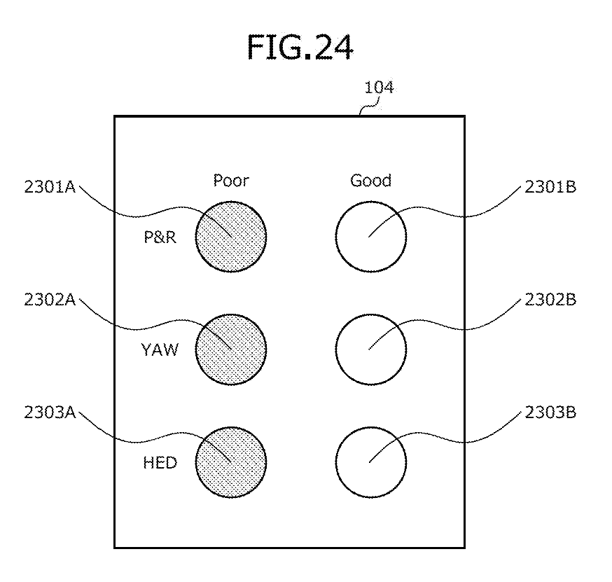

A display example of a display unit will be described. FIG. 23 is an explanatory diagram of an example of display on the display unit, and FIG. 24 is an explanatory diagram of another example of display on the display unit. In FIGS. 23 and 24, the display unit 104 constitutes a portion of the sensor 101 and is attached to the mast 111. For example, the display unit 104 is attached at a position above the boom 114 on the mast 111. As a result, the rider may view the display contents of the display unit 104 while steering the sailboard 110.

The display unit 104 is not limited to one unit. Multiple display units may be provided. Therefore, the display units may be attached to respective positions easily viewable in the case of the port tack and the case of the starboard tack. The display unit 104 using short-range wireless communication may be worn by the rider. For example, a wristwatch type information terminal device may be used as the display unit 104. The display unit 104 may be goggle type.

The display unit 104 includes rejection lamps 2301A, 2302A, 2303A and acceptance lamps 2301B, 2302B, 2303B indicating the state of the sailboard 110. The rejection lamps 2301A, 2302A, 2303A are implemented by LEDs (light emitting diodes) emitting red light when energized. The acceptance lamps 2301B, 2302B, 2303B are realized by LEDs emitting green light when energized.

The emission color of the rejection lamps 2301A, 2302A, 2303A and the emission color of the acceptance lamps 2301B, 2302B, 2303B may be distinctly-different colors such as red and green, for example. This enables the rider in the process of steering to easily and reliably comprehend a result of determination on the sailing form even on the sea where significant vibrations and splashes of water occur.

Either the rejection lamp 2301A or the acceptance lamp 2301B emits light according to whether the pitch angle and the roll angle (P & R) of the mast 111 are within the acceptable reference range 2201. For example, in the case of a Good state in which the pitch angle and the roll angle of the mast 111 are within the acceptable reference range 2201, the green acceptance lamp 2301B emits light. In contrast, in the case of a Poor state in which the pitch angle and the roll angle of the master 111 are not within the acceptable reference range 2201, the red rejection lamp 2301A emits light.

Either the rejection lamp 2302A or the acceptance lamp 2302B emits light according to whether the yaw angle (YAW) of the sail 113 is within the acceptable reference range 2211. For example, in the case of a Good state in which the yaw angle of the sail 113 is within the acceptable reference range 2211, the green acceptance lamp 2302B emits light. In contrast, in the case of a Poor state in which the yaw angle of the sail 113 is not within the acceptable reference range 2211, the red rejection lamp 2302A emits light.

Either the rejection lamp 2303A or the acceptance lamp 2303B emits light according to whether the heading angle (HED) of the sailboard 110 is within the acceptable reference range 2221. For example, in the case of a Good state in which the heading angle of the sailboard 110 is within the acceptable reference range 2221, the green passing lamp 2303B emits light. In contrast, in the case of a Poor state in which the heading angle of the sailboard 110 is not within the acceptable reference range 2221, the red rejection lamp 2303A emits light.

In this way, while in the process of steering, the rider is notified of whether the state of the sailboard 110 is within the acceptable reference ranges 2201, 2211, 2221, thereby enabling the sailing form to be corrected on the spot during steering. As a result, efficient steering/running may be supported.

Additionally, by giving notification of only the fact that the rider's sailing form satisfies the acceptance criteria according to whether the state is within the acceptable reference ranges 2201, 2211, 2221 set based on the ideal sailing form, notification may be clearly made on whether the rider's sailing form is good or poor.

Because of significant vibrations and environmental sounds (such as the sound of wind and waves) during steering, it is difficult to make the rider understand all of the notification contents even when notification of detailed data is made by using a display, etc. On the other hand, according to the sailing training support system 100, since only the notification of whether the rider's sailing form is good or poor is made by light emission of the rejection lamps 2301A, 2302A, 2303A and the acceptance lamps 2301B, 2302B, 2303B, the rider, who is in the process of steering, may be supported such that the sailing form is corrected on the spot during steering. As a result, efficient steering/running by the rider may be supported.

By notifying the rider of whether the respective states such as the pitch angle and the roll angle of the mast 111, the yaw angle of the sail 113, and the heading angle of the sailboard 110 are within the acceptable reference ranges 2201, 2211, 2221, the sailing form may be comprehended in detail even though the sailboard 110 is steered by a single person. This eliminates a need for another person to photograph the rider's sailing form from land so that the cost required for practicing may be reduced, and the efficient steering/running may be supported.

The display unit 104 includes LEDs emitting red light having longer wavelength and higher visibility than green and therefore, may reliably notify the rider of being in the Poor state. Since the rider utilizes the sailing training support system 100 with the goal of improvement, the notification of the poor state may be made more conspicuous than the Good state to provide support such that the sailing form is corrected on the spot during steering. As a result, the efficient steering/running can be supported.

Setting the acceptable reference ranges 2201, 2211, 2221 for each type of training enables the acceptance criteria for determining whether the Good state or the Poor state to be set to values suitable for the type of training. As a result, whether the sailing form is suitable for the type of training may be comprehended for each type of training on the spot during steering. As a result, the efficient steering/running may be supported.

The notification method described in the present embodiment may be implemented by executing a prepared program on a computer such as a personal computer and a workstation. The notification program is stored on a non-transitory, computer-readable recording medium such as a hard disk, a flexible disk, a compact disc (CD)-ROM, a magneto-optical disk (MO), a digital versatile disk (DVD), and a universal serial bus (USB) memory, is read out from the computer-readable medium, and executed by the computer. The program may be distributed through a network such as the Internet.

According to an aspect of the present invention, efficient steering/running may be supported.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a notification program that causes a computer to execute a process comprising:
acquiring position information regarding changing positions of a mobile body that moves by wind power;
acquiring state information regarding a state of the mobile body at each of the positions;
determining whether the state is within a predefined range; and
outputting a result of the determination.

2. The recording medium according to claim 1, the process further comprising:
calculating a running direction of the mobile body relative to a wind direction at each of the positions, based on the position information;
determining whether the running direction is within a predefined range; and
outputting a result of the determination.

3. The recording medium according to claim 1, wherein
the state information is information regarding a tilt of a mast of the mobile body.

4. The recording medium according to claim 1, wherein
the state information is information regarding a rotation angle of a sail of the mobile body.

5. The recording medium according to claim 1, wherein
the range is set for each type of training.

6. The recording medium according to claim 1, wherein the outputting of the determination result is made by using a display member provided on the movable body.

7. The recording medium according to claim 1, wherein
the position information is acquired by acquiring a GPS value.

8. The recording medium according to claim 1, wherein
the state information is acquired by acquiring a detection value from a nine-axis sensor.

9. A notification method executed by a computer, the notification method comprising:
acquiring position information regarding changing positions of a mobile body that moves by wind power;
acquiring state information regarding a state of the mobile body at each of the positions;
determining whether the state is within a predefined range; and
outputting a result of the determination.

10. A notification apparatus comprising:
a memory; and
a processor coupled to the memory, the processor configured to:
acquire position information regarding changing positions of a mobile body that moves by wind power;
acquire state information regarding a state of the mobile body at each of the positions;
determine whether the state is within a predefined range; and
output a result of the determination.
